(19) United States
(12) Patent Application Publication
(10) Pub. No.: US 2008/0173124 A1
(43) Pub. Date: Jul. 24, 2008

(54) BI-DIRECTIONAL ENGINE CONTROL ASSEMBLY

(75) Inventors: Scott Thiel, Sherwood, OR (US); William R. Johnston, Beaverton, OR (US); James Honyak, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WILLIAMS CONTROLS, INC., Portland, OR (US)

(21) Appl. No.: 12/018,118

(22) Filed: Jan. 22, 2008

Related U.S. Application Data
(60) Provisional application No. 60/897,218, filed on Jan. 23, 2007.

(51) Int. Cl. G05G 1/30; G05G 1/48

(52) U.S. Cl. 74/512; 74/560; 74/561

(57) ABSTRACT

Embodiments of the present invention relate to bidirectional rocker pedal assemblies that may be adapted for use in vehicular operations. In various embodiments, a subassembly may be coupled to a treadle and the vehicle to allow for bidirectional rotation of the treadle.

### CROSS REFERENCE TO RELATED APPLICATIONS

This application is a non-provisional application of, and claims priority to, provisional application 60/897,218, filed on Jan. 23, 2007, entitled “BI-DIRECTIONAL THROTTLE CONTROL ASSEMBLY MODULE.” The specification of the provisional application is hereby incorporated in its entirety, except for those sections, if any, that are inconsistent with this specification.

### TECHNICAL FIELD

Embodiments of the invention pertain to pedal assemblies, and in particular to a bidirectional rocker pedal assembly for use with throttle control and other vehicular applications.

### BACKGROUND

Electronic throttle control assemblies are often used in vehicular applications (e.g. trucks, cars, utility vehicles, forklifts, heavy equipment, etc.) in order to control vehicle operations, such as the speed of the engine, via a sensor sensing the degree of movement of the pedal. In such applications, a pedal is typically mounted for pivotal movement with respect to a floor board of the vehicle. An electronic sensor is coupled to the pedal and adapted to detect the movement of the pedal. The sensor then sends a corresponding output to another vehicle component to control the vehicle operation.

There are known bidirectional pedals, which can move in at least two directions with respect to a common pivot point, which allows the sensor to detect movement to a certain degree on either side of a reference or home position. These applications, however, are generally custom in nature and require numerous specialty parts that are tailored for the specific application. It is not only expensive to maintain an inventory and provide all the necessary tooling to make such components, but there is virtually no interchangeability in components.

### DRAWINGS

Embodiments of the present invention will be readily understood by the written description along with reference to the accompanying drawings and photographs. Embodiments of the invention are illustrated by way of example and not by way of limitation in the accompanying drawings, photos and/or figures.

FIG. 1 illustrates a perspective view of a rocker pedal assembly in accordance with embodiments of the present invention;

FIG. 2 illustrates an exploded view of a rocker pedal assembly in accordance with embodiments of the present invention;

FIG. 3 illustrates a partial end view of a rocker pedal assembly in accordance with embodiments of the present invention;

FIG. 4 illustrates a perspective view of a rocker pedal assembly in accordance with embodiments of the present invention;

FIG. 5 illustrates a perspective view of a rocker pedal assembly in accordance with embodiments of the present invention; and

FIG. 6 illustrates a perspective view of a rocker pedal assembly in accordance with embodiments of the present invention.

### DETAILED DESCRIPTION OF EMBODIMENTS OF THE INVENTION

In the following detailed description, reference is made to the accompanying drawings and photos which form a part hereof wherein like numerals may designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous.

Bi-directional rocker assemblies in accordance with various embodiments of the present invention can reduce the number of custom parts of known bi-direction pedals assemblies and facilitate use in a variety of applications previously not feasible without significant customization. In such embodiments, a subassembly or modular drop in component may be preassembled and used for numerous bidirectional rocker pedal applications by being coupled between components such as a treadle or treadle support and a base (e.g. a separate component adapted to couple the assembly to the vehicle floor). Embodiments of the present invention allow relative movement between one component (e.g. the treadle and/or treadle support) and the subassembly. In various embodiments, the entire assembly may be assembled such that an attached treadle can move/rock forward and aft, side-to-side, and/or other opposing directions depending on the specified needs.

In various embodiments, the subassembly/module may allow for the use of various biasing members in order to provide the desired tactile feed back to the user and/or to facilitate pedal adjustment and locate a desired neutral or home position. The subassembly may also provide the primary angular travel limit. In one example (examples of which are discussed further below) a variety of stops may be used to limit the amount of treadle travel in either direction. Such stops may be included as part of the subassembly, or may be incorporated in the component (e.g. base unit and/or treadle support), and further adapted to work in conjunction with the subassembly and biasing member to control the amount of travel/relative movement and/or vary the tactile feed back. As used herein, “treadle support” may used interchangeably with “treadle”, or may be a separate structure that allows a user specified treadle to be attached to in increase the flexibility of the subassembly.

Accordingly, bidirectional rocker assemblies in accordance with various embodiments may provide numerous functions, including but not limited to 1) applying a preload force to the biasing/spring elements, 2) control the bidirectional travel angles as desired, 3) establish and/or control the preset home or “neutral” angle configuration of the treadle support, and/or 4) be used in a variety of situations, requiring only a user specified treadle and/or user specified base.

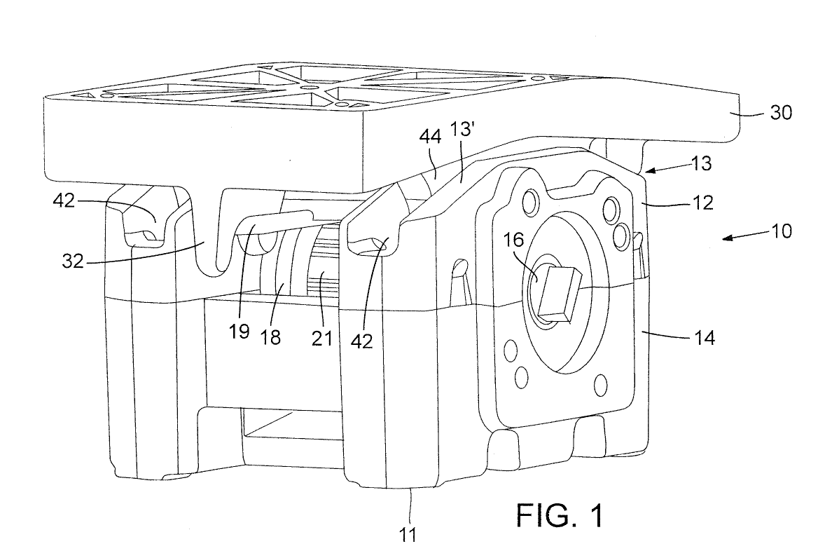

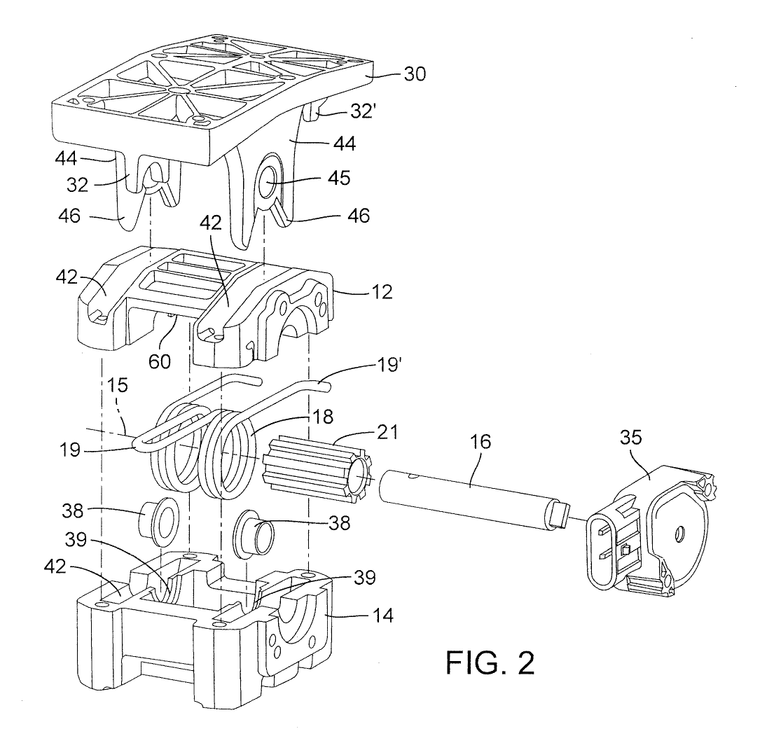

FIGS. 1 and 2 illustrate an assembled view and an exploded view of a subassembly in accordance with various embodiments of the present invention. Subassembly 10 may include a first portion 12 having a first surface 13 that is pitched and/or has slightly relieved sides 13′. Subassembly 10 may also include a second portion 14 having a second surface 11 that is adapted for coupling to another component, such as a base member, floor plate, and in some embodiments a treadle support (though not in the illustrated embodiment), such that the subassembly 10 may be generally fixed and not move with respect to the component.

The first and second portions 12 and 14 may be separate pieces coupled together. A passage may be disposed in the subassembly 10 having a rotational axis 15. In various embodiments, the first and second portions 12 and 14 maybe a single integrated piece having a passage with a central axis. An axle or shaft 16 may pass through the passage of subassembly 10 generally along rotational axis 15. A contact or non-contact sensor 35 may be coupled to shaft 16 such that it can sense the amount of rotation of shaft 16 with respect to the first and second portions 12 and 14.

A treadle support 30 may be pivotally coupled to and in various embodiments be part of subassembly 10. Treadle support may include axle or shaft members 44 that extend away from the treadle support 30. Axle members 44 may include apertures 45 that are sized to engage shaft 16. Shaft 16 may thus be fixedly coupled to treadle support 30 such that movement of the treadle support about rotational axis 15 causes rotational movement of the shaft 16. Bushings 38 may be disposed within the shaft apertures 39 of the subassembly 10 to facilitate rotational movement of the shaft 16 with shaft apertures 39. Such a coupling of shaft 16 may allow the sensor 35 to detect the amount and direction of movement of treadle support 30. The sensor may in turn send an output signal representative of the rotation of the shaft 16, and hence movement of the treadle support, in order to help control the responsiveness of the vehicle operations. Relieved edges or sides 13′ allow for limited rotational movement of the treadle support, and in some embodiments can act as a rotational movement stop or limiter.

In various embodiments, first and second portions 12 and 14 may include receivers 42 adapted to receive axle members 44. Receivers 42 may be sized to allow a desired degree of movement of the axle members 44 about the rotational axis 15. While the illustrated embodiment shows two axle members 44 and corresponding receivers 42, in various embodiments, a single axle member and single receiver may be used, and/or three or more axle members and receivers may be used. Further, in various embodiments, the receivers may be positioned such that the axle supports penetrate into the body of the first and second portions 12 and 14 (as shown), and in other embodiments, the axle supports may be sized to pass along the outside of the first and second portions 12 and 14 thus alleviating the need for generally enclosed receivers.

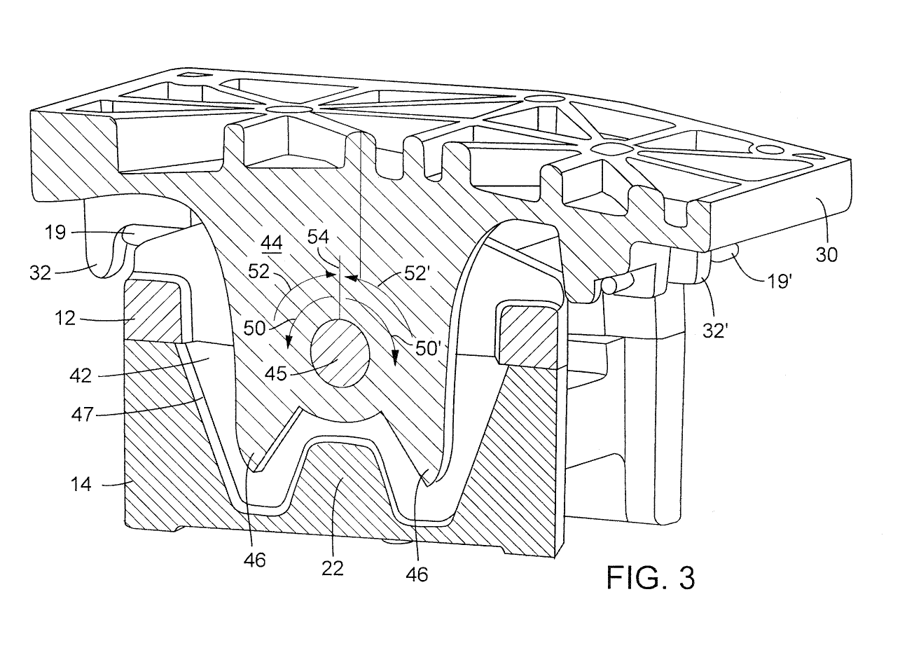

FIG. 3 illustrates a partial sectional view of the subassembly illustrated in FIGS. 1 and 2, wherein a portion of the first and second portions 12 and 14 have been removed to expose axle member 44 as disposed in the receiver 42. Axle member 44 may have member ends 46 that are configured to interface with rotational limit or stop member 22, which may be disposed, for example, in receivers 42. Thus a certain amount of movement of the treadle support 30 about the axis 15 may be allowed before the stop member 22 and the support member end 46 engage to limit further movement in a particular direction.

In various embodiments, the geometry of the stop members and/or support ends may have a number of geometric configurations, which would allow for a variety of rotational movement ranges, such as, for example, 20 degrees either way, 10 degrees one way and 20 degrees the other way, etc. In some embodiments, the stop member may have multiple stop faces adapted to interface with the support member ends 46 depending on the desired amount of rotation about the central axis. In various embodiments, the axle member ends may be changed (e.g. lengthened or shortened) in order to alter the interface with the stop member faces and thus change the amount of rotation allowed. Further, a single member end may be engage a slot-type slot in a corresponding stop member. In various other embodiments, the sloped sides 47 of the receiver may act as the stop member/movement limiter. In other embodiments, other stop configurations may be provided (whether as part of the subassembly or a base plate or other component) and adapted to limit the movement of the treadle support about the central axis.

In various embodiments, a biasing member may be disposed in or about the subassembly and adapted to help provide many of the functions noted above. For example, as the treadle support is rocked about the rotational axis, the biasing member may act on the treadle support to provide, for example, tactile feedback, hysteresis, and/or urge the treadle support back to the neutral/home position. In various embodiments, the biasing member may interface with the base and/or the treadle support in order to achieve the aforementioned functions.

Referring to the example embodiment of FIGS. 1, 2 and 3, the biasing member may be a spring 18 that is at least partially disposed in or about subassembly 10. Spring 18 may have a first and second end 19 and 19′ that extend away from the rotational axis 15 and a central portion that surrounds shaft 16. In various embodiments, a spring spacer 21 may be disposed between spring 18 and shaft 16. First and second ends 19 and 19′ may engage respective first and second loading members 32 and 32′, which may, for example, extend from the treadle support 30.

As the treadle support 30 is pivoted in direction 50 (which may represent for example forward direction), the interface between biasing member end 19 and loading member 32 causes the spring 18 to act on the treadle support 30 resist movement of the treadle support 30 in direction 50. When a force is not being applied to the treadle support in rotational direction 50, spring 18 may urge the treadle support to move in direction 52 towards a home position 54. Likewise, if treadle 30 is moved in direction 50′ (which may represent for example reverse direction), the interface between biasing member end 19′ and loading member 32′ causes the biasing member to act on the treadle support 30, which in turn may resist movement in direction 50′. When a force is not being applied to the treadle support in direction 50′, spring 18 may urge the treadle support to move in direction 52′ towards home position 54.

In various embodiments, the amount the biasing member may be allowed to act on the treadle support may be limited in order to prevent the biasing member from urging the treadle past a specified or home position 54. In one embodiment, the movement of the biasing member ends 19 and 19′ in directions 52 and 52′ respectively may be restricted by virtue of engaging bias restrictors 60 and 60′ disposed in and/or coupled to subassembly 10. Positioning of bias restrictors 60 and 60′ may also be such that the biasing member may be pre-loaded when the subassembly is in assembled form. Such preloading can be manipulated as needed to provide, for example, tactile feedback, hysteresis, and/or better urge the treadle support back to a neutral/home position. Further, such restrictors may allow for the subassembly to be a stand alone module with a preloaded biasing member, such that the subassembly need only be coupled to a component (e.g. treadle, treadle support, or base member) having load members to engage the biasing members to facilitate movement resistance.

In various embodiments, loading members 32 and 32′ may also act as a rotation limits to prevent excessive treadle support movement in any one direction. Accordingly, in various embodiments, the height and/or geometry of the loading member 42 may, for example, be altered as desired in order to vary the amount of treadle movement, enable a desired amount of biasing member loading, and/or influence the resting or home position of the treadle. In various embodiments, the loading member may be a part of other components such as a base member.

In various embodiments, a variety of biasing members may be used, such as springs and/or elasotmers. In various embodiments, a double torsion spring may be disposed within the subassembly, and have a first biasing member end and a second biasing member end, both of which may interface with loading members. The spring may be preloaded as desired and further varied depending on the interface with the loading member and movement of the treadle and/or treadle support. In various embodiments where the biasing member used is a double torsion spring, an added safety benefit may be achieved that if the one half of the spring fails, the remaining half can still return the treadle to the home position, as well as provide some operator feedback and response. In various embodiments, the spring may be rotated 180 degrees in order to change the tensioning applied on the spring by the subassembly. Other biasing members may be used, such as elastomer modules, leaf springs and/or coil springs.

In various embodiments, the second portion 14 of the subassembly 10 may be configured to mate with any one of a number of vehicle mounting configurations, either directly or through other component interfaces such as a base plate. In various embodiments, the angle of the subassembly with respect to a vehicle floor may be manipulated as desired by adjusting the subassembly mounting itself and/or the base plate mounting. Such manipulation can serve to tilt the subassembly and/or base unit up or down on one end or side in order to more ergonomically accommodate the user in, for example, either a side to side rocker application or a fore and aft rocker application. Further in various embodiments, the length of one axle members, whether disposed on the base or the treadle support may be lengthened or shortened in order to cause the treadle to have a desired tilt.

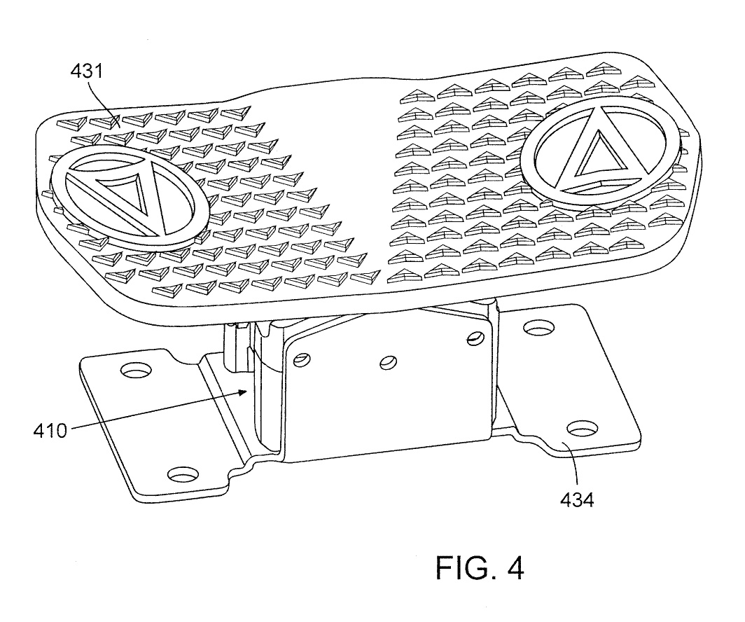

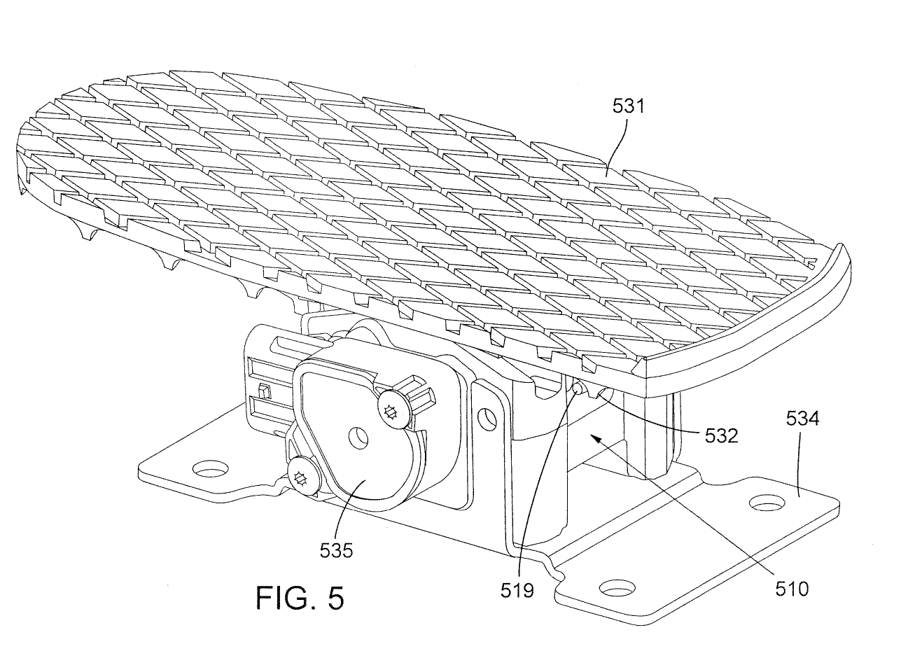

FIGS. 4 and 5 illustrate various embodiments of a subassembly and treadle support coupled to treadles and a vehicle floor. FIG. 4 illustrates a side to side configuration where the treadle 431 may be either coupled to a treadle support (not shown) or directly coupled to subassembly 410. Base member 434 may be coupled to the subassembly 410 such that no relative movement may occur between the base member and the subassembly 410. Base member 434 may be coupled to a vehicle floor.

FIG. 5 illustrates the treadle movement as being configured for fore and aft movement. In the illustrated embodiment, treadle 531 is directly coupled to the subassembly 510, where loading members 532 engages biasing member end 519. Again, in various embodiments, the component coupled to the subassembly may be a treadle support upon which the treadle is mounted. Base member 534 may be coupled to the subassembly 510 such that no relative movement may occur between the base member and the subassembly 510. Base member 534 may be further coupled to a vehicle floor. Rocking of the treadle 531 for and aft will cause the shaft (not shown) to move rotationally. Sensor 535 may sense such rotation and send signals further controlling vehicular operations.

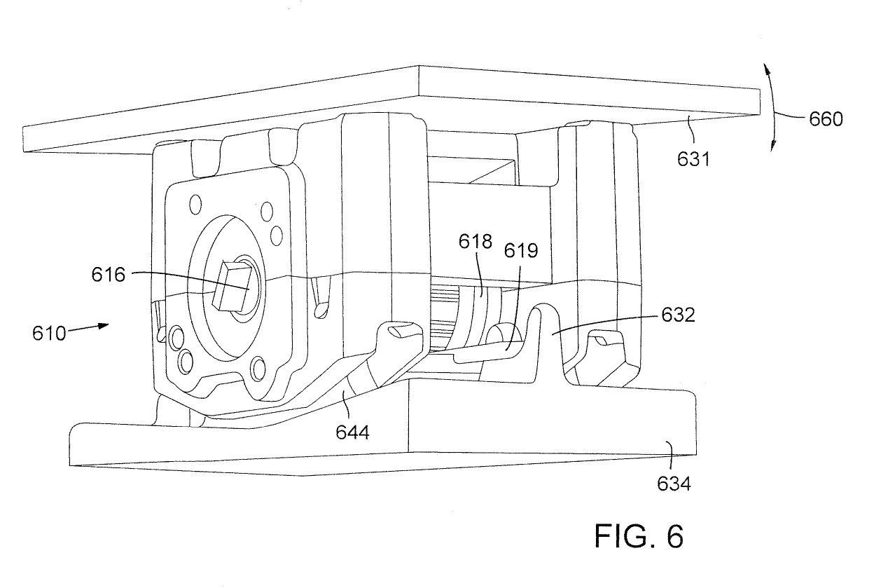

In various embodiments, the component to which the subassembly may move relative to may be a base plate that is mounted to the vehicle floor. FIG. 6 illustrates such an example. Subassembly 610 may be coupled to the treadle such that there is no relative movement between the subassembly 610 and the treadle 631. Base member 634 may be coupled to subassembly 610 such that the subassembly 610 moves relative to the base member 634 as the treadle 631 is moved as illustrated by indicator 660. In such embodiments, the base member 634 may include shaft members 644 that project away from the base support and engage the shaft 616. Like wise, base member 634 may include load members 642 that can engage ends 619 of biasing member 618 to both resist movement and urge the treadle towards a home position. Thus as the treadle support is moved about the rotational axis, the subassembly 610 also pivots about the rotational axis. With the shaft fixed to the subassembly, rotational movement of the subassembly will also cause rotational movement of the shaft thus allowing a sensor to detect the user input. Again, such embodiments are similar in operation to the illustrated embodiments, except that the subassembly generally rotates with respect to the base member.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A rocker pedal assembly, comprising
A subassembly having an aperture passing there though and defining a rotational axis;
A shaft disposed in the aperture and further adapted to couple to a sensor;
A component having one or more shaft members projecting there from, wherein the one or more shaft members and subassembly coupled to the shaft to allow the subassembly and the component to move relative to each other, wherein movement of the component and/or the subassembly about the rotational axis causes rotational movement of the shaft; and
One or more biasing members disposed within and/or about the subassembly and adapted to act on the component to resist rotational movement of the shaft from a home position in both a first direction and a second direction.

2. The rocker pedal assembly of claim 1, further comprising one or more loading members coupled to the component, wherein the one or more loading members engage the biasing member to help provide the rotational movement resistance.

3. The rocker pedal assembly of claim 2, wherein the subassembly includes one or more receivers in which the one or more shaft members engage, the one or more receivers including stops adapted to engage one or more shaft member ends to limit the rotational movement of the subassembly or the component.

4. The rocker pedal assembly of claim 2, wherein the biasing member includes a double torsion spring having a central portion disposed about the shaft and first and second ends extending in generally opposite directions from the central portion, and wherein the first end engages a first loading member and the second end engages a second loading member.

5. The rocker pedal assembly of claim 4, wherein the subassembly further includes a first bias restrictor adapted to restrict movement of the first spring end in the first direction and a second bias restrictor adapted to restrict movement of the second spring end in the second direction.

6. The rocker pedal assembly of claim 2, wherein the subassembly has a first surface having relieved edges adapted to allow for movement of the subassembly relative to the component.

7. The rocker pedal assembly of claim 2, wherein the component is a treadle, a treadle support adapted to couple to the treadle, or a base member adapted to couple to a floor of a vehicle.

8. A vehicle rocker pedal assembly, comprising
A subassembly having a first surface having relieved edges and a second surface, the subassembly further comprising an aperture passing there though defining a rotational axis;
A shaft rotatably disposed in the aperture and further adapted to couple to a sensor;
A treadle support having one or more shaft members projecting there from, the one or more shaft members engaged with the shaft to allow the treadle support to move about the rotational axis and the subassembly to stay stationary, wherein movement of the treadle support about the rotational axis causes rotational movement of the shaft;
One or more biasing members disposed within and/or about the subassembly and adapted to act on the component to resist rotational movement of the shaft in a first direction and a second direction;
one or more loading members coupled to the treadle support, wherein the one or more loading members engage the one or more biasing member to help provide the rotational resistance; and
wherein the subassembly further includes bias limiters adapted to restrict movement of the treadle support in the first direction and/or the second direction.

9. The rocker pedal assembly of claim 8, wherein the subassembly includes one or more receivers in which the one or more shaft members engage, the one or more receivers including stops adapted to engage one or more shaft member ends to limit the rotational movement of the subassembly or the component.

10. The rocker pedal assembly of claim 8, wherein the treadle support is a treadle.
